(19) United States
(12) Patent Application Publication
(10) Pub. No.: US 2008/0191884 A1
(43) Pub. Date: Aug. 14, 2008

(54) Identifying Unit, Dispensing Member Equipped With Same and Method For Making Same

(75) Inventors: Firmin Garcia, Evreux (FR); Gerard Cornet, Blaru (FR)

Correspondence Address: SUGHRUE MION, PLLC, 2100 PENNSYLVANIA AVENUE, N.W., SUITE 800, WASHINGTON, DC, 20037, US

(73) Assignee: VALOIS S.A.S, Le Prieure, Le Neubourg (FR)

(21) Appl. No.: 11/663,637

(22) PCT Filed: Sep. 29, 2005
(86) PCT No.: PCT/FR05/02411

§ 371 Date: Oct. 3, 2007

(30) Foreign Application Priority Data
Oct. 1, 2004 (FR) 0452229

(51) Int. Cl. G08B 13/14; B67D 5/06

(52) U.S. Cl. 340/572.8; 222/23

(57) ABSTRACT

An ID unit for associating with an article and that is suitable for delivering at least one item of data relating to said article, said unit comprising ID means that are suitable for delivering said data, the ID unit being characterized in that it further comprises: a base support on which the ID means are mounted; and a coating that is disposed on the support and the ID means in such a manner as to hermetically isolate the ID means from the outside.

The present invention relates to an identity (ID) unit for associating with an article, such as a pump or a valve, for example, and more generally a fluid dispenser. The ID unit includes ID means that are suitable for delivering data that makes it possible to identify the article with which the ID unit is associated. The data relating to the article makes it possible to verify the authenticity of the article, or even to ensure traceability of the article. Such an ID unit can be associated with any type of article, and in particular a fluid dispenser member, such as a pump or a valve. In addition, the present invention also relates to a fluid dispenser member fitted with such an ID unit. Furthermore, the present invention relates to a method of manufacturing such an ID unit. Amongst fluid dispenser members, the present invention applies more particularly to pumps and to valves used in the fields of perfumery, cosmetics, or even pharmacy.

A known type of ID means uses a small printed circuit plate associated with an antenna. That type of ID means is known under the term “transponder”, for example. The electronic circuit of the plate makes it possible to store data in a memory, while the purpose of the antenna is to make it possible for the data stored in the electronic circuit to be transmitted and received remotely. That type of ID means does not even require a power source in order to receive and transmit data. It is the external radiation received by the antenna that enables the ID means to be powered, and that thus enables data to be transmitted. The ID means are thus completely passive, although electronic.

Such ID means having an electronic circuit and an antenna have already been associated with a fluid dispenser member, such as a pump or a valve, as can be seen from document FR-2 832 134. That document describes an embodiment in which the ID means are embedded in a support ring that is engaged around the body of the valve or of the pump. The ID means can be merely placed on, or even embedded in, the support ring. In another embodiment, the ID means can be placed in the body or on a wall constituting the body by an encapsulating or an embedding method. That description is entirely conceptual or theoretical about mounting the ID means on the pump or the valve.

An object of the present invention is to define an entirely practical embodiment that makes it possible to implement ID means on any article, such as a pump or a valve, for example.

As a result, the present invention proposes an ID unit for associating with an article and that is suitable for delivering at least one item of data relating to said article, said unit comprising ID means that are suitable for delivering said data, the ID unit being characterized in that it further comprises: a base support on which the ID means are mounted; and a coating that is disposed on the support and the ID means in such a manner as to hermetically isolate the ID means from the outside.

The fact that the ID means are hermetically isolated from the outside is advantageous, particularly when the ID unit must be, or must remain, in contact with a medium with which the ID means could interact in such a manner as to deteriorate or change the characteristics of the medium. This occurs particularly in pumps or valves when the ID unit is in contact with the fluid to be dispensed. In particular, it is known that alcohol-based fluids, such as perfumes, can interact with many substances and materials, such as adhesives, for example. Under no circumstances must the perfume be able to extract or combine in such a manner as to produce substances that could be harmful to the environment or to the user.

In addition, the fact of mounting the ID means on a support that is then coated constitutes a technique that is relatively simple and inexpensive. The ID means are thus disposed between the support and the coating.

In a practical embodiment, the base support is generally cylindrical, in such a manner as to form a hollow inside and an outer wall, the ID means being mounted on the outer wall, the coating covering the ID means and at least part of the outer wall. The hollow inside may serve as housing means for receiving the body of the pump or of the valve, or more generally a portion of the article. The ID unit may thus be fastened to the article. In addition, the coating may cover all of the outer wall, such that the base support is no longer even visible once the ID unit is mounted on the article. The support advantageously forms a reception housing for the ID means.

In a practical embodiment, the ID means comprise an electronic circuit plate and an antenna, the antenna is disposed in coiled manner around the support under the coating. The ID means are of the conventional transponder type. In this event, the electronic circuit plate can be received in a reception housing formed by the support. With regard to the antenna, it may be disposed in coiled manner around the outer wall of the base support. By way of example, the antenna may be in the form of a small cylinder.

In a particularly advantageous characteristic, the coating is overmolded on the support and the ID means. The overmolding technique makes it possible to avoid the use of adhesive or resin that could interact with a medium of the article. For example, with pumps and valves, said pumps and valves can be brought into contact with the fluid stored inside the reservoir. Some fluids, such as perfumes, for example, are likely to interact with numerous materials, consequently spoiling the perfume and sometimes even making it unusable. With the overmolding technique, it is easier to control the materials coming into contact with the medium (fluid) quite simply by selecting a material for the coating that is completely inert in the presence of the medium of the article. In addition, overmolding provides intimate contact that guarantees perfect sealing. This is not true when the receiver means are merely disposed inside a housing that is mechanically closed by clamping, by snap-fastening, or even by adhesive.

The invention also provides a fluid dispenser member, such as a pump or a valve, including an ID unit as defined above.

In a first embodiment, the dispenser member comprises a body for mounting in stationary manner in an opening of a fluid-containing receptacle, the ID unit being engaged around the body. The ID unit advantageously forms a bearing collar for coming to bear against the opening of the receptacle. The bearing collar may even serve as a neck gasket making it possible to seal the fluid dispenser.

In a variant, the dispenser member comprises a body for mounting in stationary manner in an opening of a fluid-containing receptacle, the base support being formed by the body. In this event, the body of the pump or of the valve is used directly as the base support on which the ID means are mounted before being coated in leaktight manner.

The invention also defines a method of manufacturing an ID unit, the method comprising the following steps of disposing ID means around a base support, and of then overmolding a leaktight coating on the support and the ID means, such that the ID means are embedded in leaktight manner between the support and the overmolded coating.

The invention is described more fully below with reference to the accompanying drawings which show several embodiments of the invention by way of non-limiting example.

In the drawings:

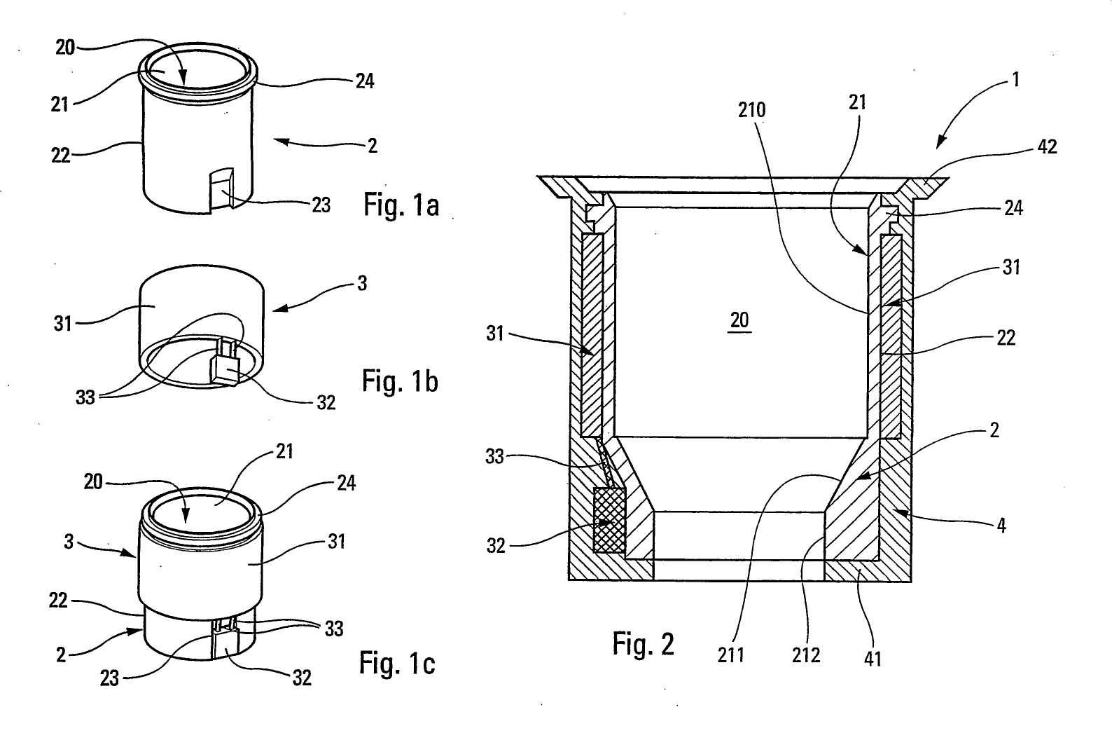

FIG. 1a is a perspective view of a base support for supporting an ID unit constituting a first embodiment of the invention;

FIG. 1b is a perspective view of ID means constituting an embodiment of the invention;

FIG. 1c is a perspective view of the FIG. 1b ID means mounted on the FIG. 1a base support;

FIG. 2 is a larger-scale vertical section view of an ID unit constituting a first embodiment using the FIG. 1a base support and the FIG. 1b ID means;

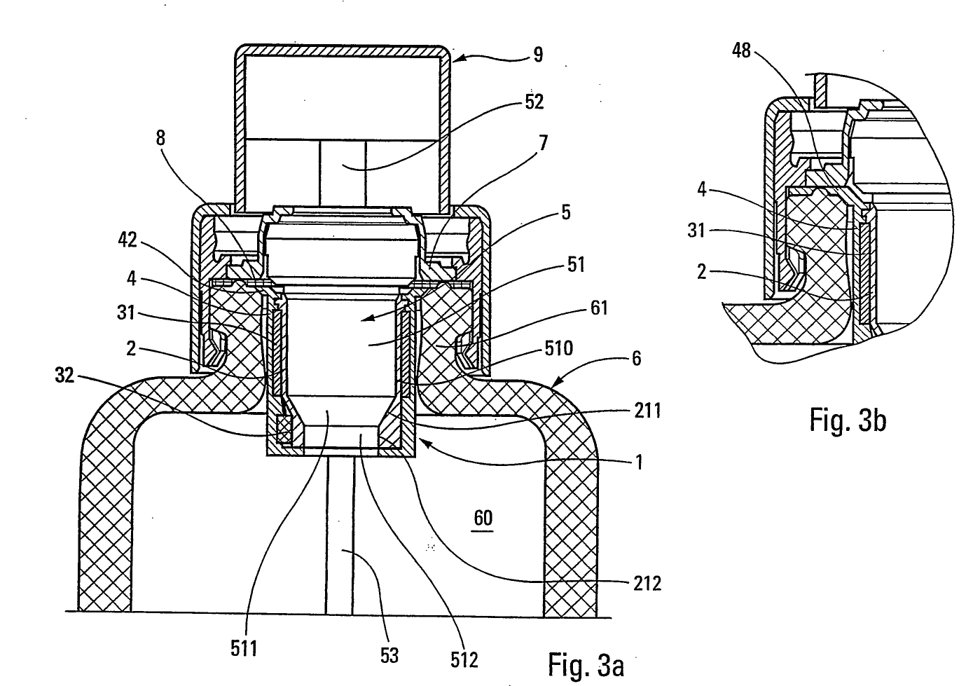

FIG. 3a is a vertical section view through a fluid dispenser including a dispenser member provided with an ID unit constituting the first embodiment in FIG. 2;

FIG. 3b is a view similar to the view in FIG. 3a for a variant embodiment;

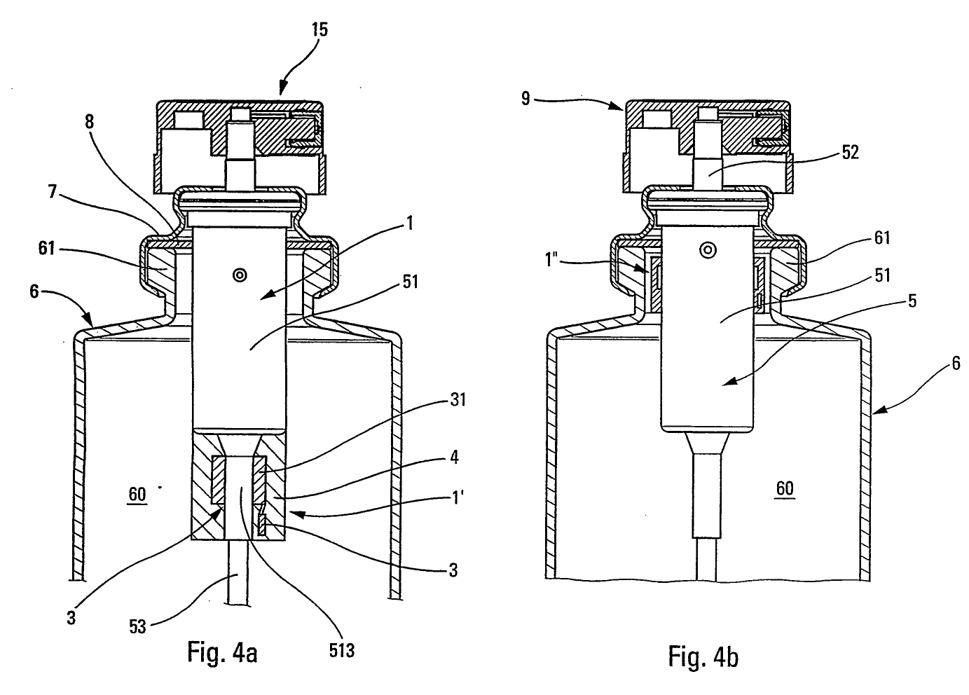

FIG. 4a is a vertical section view through a fluid dispenser including a dispenser member fitted with an ID unit constituting a second embodiment of the invention; and

FIG. 4b is a variant of FIG. 4a.

The ID unit of the invention can be associated with, mounted on, fastened to, or incorporated in any type of article for the purpose of delivering one or more items of data relating to the article. The data relating to the article can be of any kind, such as its date or its place of manufacture, its destination, its shipping date, its reception date, its place of reception, or even a mere identification number or code, for example. One of the purposes of the ID unit is to make it possible to authenticate and/or to trace the article. In FIGS. 3, 4a, and 4b, the ID units of the invention are mounted on or associated with a fluid dispenser member, such as a pump or a valve, mounted on a receptacle or flask containing a fluid, liquid, or powder.

The various figures show two main embodiments, namely the embodiment in FIGS. 1a, 1b, 1c, 2, and 3, and the embodiment in FIGS. 4a and 4b, although FIG. 4b is a variant of FIG. 4a.

Reference is made firstly to FIGS. 1a, 1b, 1c, and 2, which show an ID unit constituting a first embodiment in which the ID unit constitutes an element that is separate and distinct from the article on which it is to be mounted or with which it is to be associated. In the invention, the ID unit comprises three component elements, namely a base support 2, ID means 3, and a coating 4. This three-element structure is also the structure of the second embodiment in FIGS. 4a and 4b. The ID means 3 are mounted on the base support 2, and the coating 4 comes to cover the ID means 3 and a portion of the base support 2. This constitutes a basic structure for the ID unit of the invention.

The base support 2 can be made as a single part out of any material, preferably a material that is moldable, such as a plastics material. The base support 2 presents a generally substantially cylindrical shape. The support 2 presents a hollow inside 20 that can advantageously serve as a reception housing for a portion of the article on which the ID unit is mounted or with which the ID unit is associated. The support 2 thus presents an inner wall 21 defining the hollow inside 20, and an outer wall 22. In this embodiment, although generally cylindrical, the inner wall 21 presents a main top portion 210 of perfectly cylindrical shape that is extended downwards by a frustoconical intermediate portion 211 that narrows so as to be extended finally by another bottom cylindrical portion 212. The hollow space 20 thus presents a top opening that is larger than its bottom opening. It can easily be understood that the frustoconical portion 211 can serve as a bearing or abutment surface against which the article can come to bear in stable manner. In this embodiment, the outer wall 22 is cylindrical over the major portion of its height, except at its top end where the outer wall forms a holding rib 24 having a function that is explained below. The outer wall 22 also forms a reception housing 23 that is situated substantially at its bottom edge, when looking at FIG. 1.

The above-described base support 2 constitutes only one particular embodiment that should not be considered as limiting. The base support could present a configuration other than cylindrical, e.g. perfectly plane or even in the form of a disk. The base support can be formed without a holding rib 24 and without a reception housing 23. The support 2 could be perfectly cylindrical.

In this embodiment, the ID means 3 comprise an antenna 31 that is connected to an electronic or printed circuit plate 32 via connection wires 33. In this embodiment, the antenna 31 is in the form of a cylindrical coil of conductive wires. Naturally, it is possible to imagine other shapes for the antenna 31, such as being perfectly plane or even in the form of a disk, for example. The circuit plate 32 includes electronic components that makes it possible to provide a data storage or memory function. The antenna 31 serves as a transceiver, making it possible to receive data to be stored in the memory of the circuit plate 32, and to transmit data that is stored in the memory of the circuit plate 32. The antenna 31 also serves as a power transmitter for powering the circuit plate 32. This type of ID means is better known under the term “transponder” using radio frequency identification (RFID) technology. Such transponders are commercially available.

In the invention, the ID means 3 are mounted on the support 2, such that the antenna 31 is engaged or fitted around the outer wall 22 of the support 2. Furthermore, the circuit plate 32 can advantageously be received in the housing 23. This intermediate mounting step is shown in FIG. 1c. The antenna 31 can come into abutment below the holding rib 24. However, it should be observed that the holding rib 24 and the bottom portion of the outer wall 22 are not covered by the antenna 31.

In the invention, a portion of the support 2 and the ID means 3 are covered by a coating 4. It would also possible to speak of a covering or a casing or a sheath. The ID means are advantageously isolated in leaktight manner from the outside by being held captive between the support 2 and the coating 4. This can be seen in FIG. 2. The coating 4 extends all around the holding rib 24, the antenna 31, and the bottom part of the support in which the circuit plate 32 is mounted. Finally, the coating provides a bottom inwardly-directed rim 41 that makes it possible to encapsulate the circuit plate 32. At its top end, the coating forms a bearing collar 42 having a function that is explained below. In the invention, the coating 4 is advantageously overmolded on the support 2 and the ID means 3. The overmolding technique makes it possible to guarantee perfect sealing, thereby ensuring that the ID means are encapsulated or embedded in perfect manner. In addition, the overmolding technique makes it possible to eliminate any need to use glue, adhesive, or resin. This is particularly advantageous when the ID unit is in contact with a medium that is likely to generate unpredictable interactions or combinations, as with perfume in particular. By selecting a completely inert material for the coating, the ID unit is guaranteed to be completely inert for the medium with which it is to come into contact.

Reference is made to FIG. 3a, which shows a fluid dispenser of the perfume spray type including a receptacle or flask 6 forming a neck 61. The flask defines an internal working volume or reservoir 60 for containing a fluid, e.g. perfume. It is known that the perfume comprises numerous components, often unlistable and unidentifiable, that are likely to interact or to combine with other components or substances. In the dispenser, the ID unit constituting the first embodiment in FIG. 2 is mounted on a pump 5 that is fastened in the neck 61 of the receptacle by means of a fastener ring 7. In order to guarantee sealing at the neck 61, a neck gasket 8 is used that is flattened against the top edge of the neck by the fastener ring 7. The pump 5 comprises a body 51 that is engaged with the fastener ring 7. The pump 5 further comprises an actuator rod on which a dispenser head 9 is mounted. The user presses on the dispenser head 9 so as to displace the actuator rod 52 and thus actuate the pump 5. In response, a quantity of perfume is dispensed from the head 9. The pump 5 can optionally be fitted with a dip tube 53 that extends inside the reservoir 60. The ID unit 1 is disposed around the body 51 of the pump 5 with or without clamping contact. The body 51 can be engaged in clamping contact inside the support 2 having a hollow inside that thus serves as a reception space for the pump 5. In a variant, the body 51 of the pump 5 can be disposed with clearance inside the support 2. In this event, the ID unit 1 is fastened inside the neck 61 by means of the bearing collar 42 that comes to rest on the top end of the neck 61. The bearing collar 42 thus fulfils a function of holding the ID unit in the neck 61 of the receptacle 6. Naturally, the ID unit could be fastened more securely by clamping the pump inside the ID unit. By way of example, the body 51 of the pump 5 could be made with a plurality of sections having distinct shapes, namely a perfectly cylindrical main section 510, a frustoconical intermediate section 511, and a bottom section 512. As can be seen in FIG. 3, the section 510 can come into clamping engagement in the section 210 of the support 2, the frustoconical section 511 can come to bear against the frustoconical portion 211 of the support 2, and the cylindrical bottom section 512 can come into engagement in the cylindrical portion 212. It is also possible for the coating 4 to come into clamping engagement inside the neck 61. It is also possible for the coating 4 to be formed integrally with the neck gasket, as shown in FIG. 3b. More generally, the ID unit can form the neck gasket. This is a characteristic that is protectable in itself, regardless of the structure of the ID unit.

The ID unit 1 is thus disposed between the neck 61 and the pump 5, in contact with the fluid contained in the reservoir. By selecting a particularly inert material for the coating, and advantageously also for the support, it is guaranteed that there will be no interaction between the ID unit and the fluid to be dispensed.

Reference is made below to FIGS. 4a and 4b to explain the second embodiment of the invention. In the second embodiment, the ID unit also comprises a support, ID means, and a coating. The ID means can be identical to the ID means of the first embodiment. The coating can be made with the same overmolding technique as in the first embodiment. However, in this embodiment, the base support of the ID unit is formed directly by the body 51 of the pump 5. In the embodiment in FIG. 4a, the pump body 51 forms a bottom inlet tube 513 that is used for fastening the dip tube 53. In its top portion, the inlet tube 513, that forms an integral part of the pump body 51, presents a diameter that is less than the diameter of the pump body. In the invention, the ID means 3 are engaged around the tube 513, then the coating 4 is overmolded on the ID means 3 and the tube 513. By way of example, it is possible to make the coating 4 in such a manner that it extends downwards, extending the top cylindrical portion of the body 51, as can be seen in FIG. 4a. In this way, the ID unit is practically invisible to the user. In the variant embodiment in FIG. 4b, the ID unit 1″ is mounted on the pump body 51 directly inside the neck 61. Once again, the ID means 3 are disposed around the body 51 and the coating 4 is overmolded on the ID means and the pump body. This variant makes it possible to hide the ID unit inside the neck 61. Thus, in the second embodiment in FIGS. 4a and 4b, it is the pump body itself that serves as base support on which the ID means 3 are mounted before being overmolded with the coating 4.

1. A fluid dispenser member (5), such as a pump or a valve, comprising an ID unit (1; 1′; 1″) that is suitable for delivering at least one item of data, said unit comprising ID means (3) that are suitable for delivering said data, the unit further comprises:
a base support (2; 51) on which the ID means are mounted; and
a coating (4) that is disposed on the support and the ID means in such a manner as to hermetically isolate the ID means from the outside;
the fluid dispenser member being characterized in that the coating (4) is overmolded on the support (2; 51) and the ID means (3).

2. A dispenser member according to claim 1, in which the ID means are disposed between the support and the coating.

3. A dispenser member according to claim 1, in which the base support is generally cylindrical, in such a manner as to form a hollow inside (20) and an outer wall (22), the ID means (3) being mounted on the outer wall, the coating (4) covering the ID means and at least part of the outer wall.

4. A dispenser member according to claim 1, in which the support forms a reception housing (23) for the ID means (3).

5. A dispenser member according to claim 1, in which the ID means (3) comprise an electronic circuit plate (32) and an antenna (31), the antenna is disposed in coiled manner around the support (2; 51) under the coating (4).

6. A dispenser member according to claim 5, in which the electronic circuit plate (32) is received in a reception housing (23) formed by the support (2).

7. A fluid dispenser member according to claim 1, comprising a body (51) for mounting in stationary manner in an opening (61) of a fluid-containing receptacle (6), the ID unit being engaged around the body (51).

8. A fluid dispenser member according to claim 7, in which the ID unit forms a bearing collar (42) for coming to bear against the opening (61) of the receptacle.

9. A fluid dispenser member according to claim 7, in which a neck gasket (48) is disposed on the opening of the receptacle, said gasket being formed by the ID unit.

10. A fluid dispenser member according to claim 1, comprising a body (51) for mounting in stationary manner in an opening (61) of a fluid-containing receptacle (6), the base support being formed by the body (51).

11. A method of manufacturing an ID unit according to claim 1, the method comprising the following steps:
disposing ID means (3) around a base support (2); and
overmolding a leaktight coating (4) on the support (2) and the ID means (3), such that the ID means are embedded in leaktight manner between the support and the overmolded coating.
